(19) United States
(12) Patent Application Publication
(10) Pub. No.: US 2012/0227398 A1
(43) Pub. Date: Sep. 13, 2012

(54) EXHAUST GAS TURBOCHARGER, MOTOR VEHICLE AND METHOD FOR ASSEMBLING AN EXHAUST GAS TURBOCHARGER

(75) Inventor: Christian Uhlig, Worms (DE)

(73) Assignee: CONTINENTAL AUTOMOTIVE GMBH, HANNOVER (DE)

(21) Appl. No.: 13/509,512

(22) PCT Filed: Oct. 22, 2010
(86) PCT No.: PCT/EP2010/065973

§ 371 Date: May 11, 2012

(30) Foreign Application Priority Data
Nov. 12, 2009 (DE) 10 2009 052 961.6

(51) Int. Cl. F02B 37/013; F02B 33/40; B23P 19/04; F02C 6/12

(52) U.S. Cl. 60/605.1; 29/469; 29/525.02

(57) ABSTRACT

An exhaust gas turbocharger, in particular for an internal combustion engine of a motor vehicle, has a bearing housing for supporting an impeller shaft and a compressor housing receiving a compressor disc. A clamping device with a first arm section and an engagement section, wherein the first arm section contacts a surface of the bearing housing at least in sections, and a counter-clamping device with a head segment and a counter-engagement section. The head section contacts a first surface of the compressor housing at least in sections, and the counter-engagement section can be brought into form-fit contact with the engagement section, such that the bearing housing and the compressor housing; are connected to each other by way of a force fit. The invention also includes a motor vehicle and a method for assembling such an exhaust gas turbocharger.

Exhaust gas turbocharger, motor vehicle and method for assembling an exhaust gas turbocharger

The present invention relates to an exhaust gas turbocharger, a motor vehicle and a method for assembling an exhaust gas turbocharger of this kind.

DE 10 2004 041 166 A1 describes the known construction of an exhaust gas turbocharger for a motor vehicle, which essentially comprises a radial turbine and a radial compressor arranged in the intake section of the engine and having a compressor wheel which is coupled to a turbine wheel of the radial turbine for conjoint rotation by a turbocharger shaft. In operation, the exhaust gas flow, which has a high kinetic and thermal energy, drives the turbine wheel, which imparts rotation to the compressor wheel by way of the coupling to the turbocharger shaft. The radial compressor draws in air and compresses it, thereby ensuring that a correspondingly larger mass of fresh air and hence more oxygen is available in the intake section of the engine than is the case with a conventional naturally aspirated engine. This increases the engine mean pressure and hence the engine torque, leading to a higher engine power output.

The exhaust gas turbocharger has a turbocharger housing, which essentially comprises a compressor housing for receiving the compressor wheel, a turbine housing for receiving the turbine wheel and a bearing housing for receiving the turbocharger shaft. These compressor, turbine and bearing housings are connected to one another by screws or clamping devices. Owing to the high thermal stress to which the turbine housing and the bearing housing are exposed by the exhaust gas flow, said housings are generally designed as heavy and hence expensive cast-iron components, which are preferably connected to one another by tie bolts. For assembly, these tie bolts are passed through the bearing housing and screwed to the turbine housing.

For reasons of cost and weight, the compressor housing, which is subjected to less thermal stress, is typically embodied as a comparatively light and easy to manufacture diecast aluminum component. The compressor housing is typically fixed on the bearing housing by means of a flange structure, the general practice being to insert a circumferential collar on the bearing housing into a corresponding recess in the compressor housing and to press the bearing housing nonpositively against the compressor housing by means of a screwed fastening. In the flange region, there is a certain offset in the axial direction between the compressor housing and the bearing housing, with the bearing housing projecting beyond the compressor housing. The screwed fastening, which is generally designed as a multiplicity of threaded screws distributed uniformly over a flange circumference of the compressor housing, is passed through the compressor housing from the side of the compressor housing facing the bearing housing. That is to say, the threaded screws are installed in the opposite direction to the tie bolts of the turbine housing. Owing to the different directions of installation of the screwed fastenings, the exhaust gas turbocharger must thus be reclamped while being assembled in an assembly fixture. For this reason, however, only expensive and time-consuming manual assembly of the exhaust gas turbocharger is possible, rather than automated assembly.

In addition, there is the fact that washers are provided under the screw heads of the threaded screws to bridge the axial offset between the bearing housing and the compressor housing. Owing to the axial offset, these washers are askew relative to the center lines of the threaded screws and therefore make only point contact with the bearing housing and the compressor housing respectively. As a result, the permissible surface pressure on the aluminum material of the compressor housing is significantly exceeded. Moreover, it is not possible with this arrangement to achieve a sufficient preload on the screwed joint to compensate for settling processes. The only possible spring travel is provided by the thickness of the washers. Owing to the inadequate preload, the screwed fastening may even come loose and, in the worst case, this may even result in damage to the turbocharger or to the internal combustion engine. Moreover, the screw heads of the threaded screws greatly restrict access from the side for water and oil connections, required for the bearing assembly of the turbocharger shaft, to the bearing housing.

Alternative means of fastening the compressor housing to the bearing housing include tapered ring joints or retaining strap joints, for example. However, tapered ring joints are of more complex design than screwed joints and are therefore not preferred. Moreover, it is not possible to automate the fitting of a tapered ring, and it must likewise be performed manually, but this is something to be avoided, given the increasing trend toward automation. Retaining strap joints also require an involved redesign of the flange regions of the compressor housing and of the bearing housing and can likewise only be installed manually and therefore in an expensive and time-consuming way.

This is, of course, something to be avoided.

Given this background, it is the underlying object of the present invention to improve the assembly of the housing components in an exhaust gas turbocharger.

According to the invention, this object is achieved by an exhaust gas turbocharger having the features of patent claim and/or by a motor vehicle having the features of patent claim 13 and/or by a method having the features of patent claim 14.

Accordingly, the following are provided:

An exhaust gas turbocharger, in particular for an internal combustion engine of a motor vehicle, having a bearing housing for supporting a rotor shaft, having a compressor housing for receiving a compressor wheel, having a clamping device, which has a first arm section and an engagement section, wherein the first arm section rests at least partially on a surface of the bearing housing, and having a counter-clamping device, which has a head section and a counter-engagement section, wherein the head section rests at least partially on a first surface of the compressor housing, and wherein the counter-engagement section can be brought into positive contact with the engagement section in such a way that the bearing housing and the compressor housing can be connected to one another nonpositively.

A motor vehicle which is equipped with an exhaust gas turbocharger of this kind.

A method for assembling an exhaust gas turbocharger of this kind, comprising the following assembly steps, which are carried out in succession: clamping the turbine housing on an assembly fixture; connecting the bearing housing to the turbine housing tie bolts, wherein the tie bolts are passed through the bearing housing from a side of the bearing housing facing away from the turbine housing; connecting the compressor housing to the bearing housing the clamping device and the counter-clamping device, wherein the counter-clamping device is passed through the compressor housing from a side of the compressor housing facing away from the bearing housing, and unclamping the turbine housing from the assembly fixture.

The concept underlying the present invention is then inter alia that the compressor housing and the bearing housing are connected nonpositively to one another by the clamping device in positive engagement with the counter-clamping device. The direction in which the counter-clamping devices are installed, from a side of the compressor housing facing away from the bearing housing, is the same as that of the tie bolts of the turbine housing, thereby eliminating the need for the turbocharger to be reclamped and assembled manually when being assembled in the assembly fixture.

With the exhaust gas turbocharger according to the invention and with the method according to the invention for assembling a turbocharger of this kind, fully automated and hence time- and cost-saving assembly of the exhaust gas turbocharger can thus be carried out.

Advantageous embodiments and developments of the present invention will emerge from the dependent claims and from the description in conjunction with the figures of the drawing.

In a preferred embodiment of the present invention, the counter-clamping device is passed at least partially through an aperture in the compressor housing. As a result, an advantageous self-alignment of the screw-fastened housing parts during the installation of the counter-clamping device is possible, thereby simplifying the assembly of the turbocharger according to the invention.

In a typical embodiment of the present invention, the arm section has a first bearing section intended to rest on the surface of the bearing housing and a first intermediate section for transmitting a force from the engagement section of the clamping device to the first bearing section. It is thereby advantageously possible to bridge an offset between the bearing housing and the compressor housing by means of the intermediate section, thereby improving the ease with which the exhaust gas turbocharger according to the invention can be assembled.

In a further preferred embodiment of the present invention, the first bearing section forms a linear contact region with the surface of the bearing housing. This reduces the surface pressure in the contact region between the first bearing section and the surface of the bearing housing.

In a particularly preferred embodiment of the present invention, the clamping device comprises an elastic material, in particular a spring-elastic element, thereby making it possible to produce a preload between the bearing housing and the compressor housing. This is an advantageous way of avoiding the connection between the bearing housing and the compressor housing coming loose by itself during the operation of the exhaust gas turbocharger, thereby reliably preventing damage to the exhaust gas turbocharger according to the invention.

In another preferred embodiment of the present invention, the engagement section and the counter-engagement section have thread turns, by means of which the positive contacts are formed. A positive contact between the clamping device and the counter-clamping device is thereby made possible in a manner which is simple and is economical to produce.

In an equally preferred embodiment of the present invention, the engagement section is arranged at least partially between the first surface of the compressor housing and the surface of the bearing housing in a connected state of the bearing housing and of the compressor housing. This keeps free the area above the surface of the bearing housing, thereby significantly improving accessibility for water and cooling lines to the bearing housing.

In an embodiment of the present invention which is an alternative to the one above but is equally preferred, the clamping device has a second arm section, which rests at least partially on a second surface of the compressor housing, wherein the second surface is arranged substantially in the opposite direction to and at a distance from the first surface of the compressor housing. By means of the second arm section, the required contact force between the bearing housing and the compressor housing is advantageously distributed, thereby significantly reducing the surface pressure which is reached. This increases the reliability of the joint between the bearing housing and the compressor housing.

In another preferred embodiment of the present invention, the second arm section of the clamping device has a second bearing section intended to rest on the second surface of the compressor housing and a second intermediate section for transmitting a force from the engagement section of the clamping device to the second bearing section. This advantageously makes it possible to compensate for an offset between the compressor housing and the bearing housing, thereby significantly improving the ease with which the exhaust gas turbocharger according to the invention can be assembled.

In an equally preferred embodiment of the present invention, the second bearing section forms a linear contact region with the second surface of the compressor housing. This is a reliable way of preventing the permissible surface pressure for the aluminum material of the compressor housing being exceeded. This increases the reliability and life of the exhaust gas turbocharger according to the invention.

In an equally preferred embodiment of the present invention, the engagement section of the clamping device is arranged in front of the first and the second surface of the compressor housing and in front of the surface of the bearing housing. By virtue of this advantageous arrangement, the clamping device acts in the form of a spring and, as a result, an adequate preload is maintained, despite any settling behavior. This increases the reliability and operational safety of the exhaust gas turbocharger according to the invention.

In a typical embodiment of the present invention, the exhaust gas turbocharger has a turbine having a turbine housing, in which a turbine wheel is arranged, and a compressor having the compressor housing and the compressor wheel, wherein the rotor shaft connects the turbine wheel and the compressor wheel for conjoint rotation, and wherein the turbine housing is connected to the bearing housing by means of tie bolts. As a result, the exhaust gas turbocharger according to the invention can be used to exploit the thermal and kinetic energy of an exhaust gas stub in order to produce an increase in the power of an internal combustion engine.

Within reason, the above embodiments can be combined in any desired manner.

The present invention is explained in greater detail below with reference to the embodiments indicated in the schematic figures of the drawing, in which:

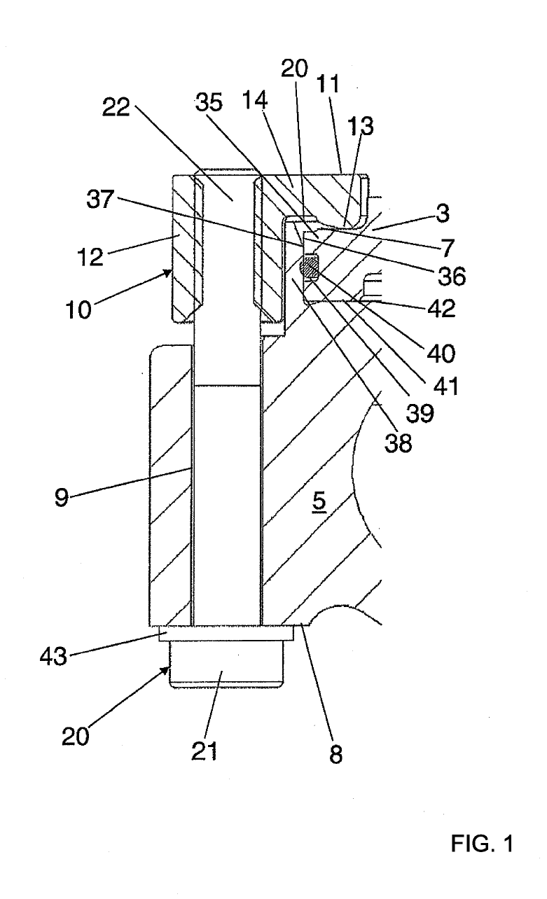

FIG. 1 shows a partial view of a cross section through a preferred embodiment of an exhaust gas turbocharger according to the invention;

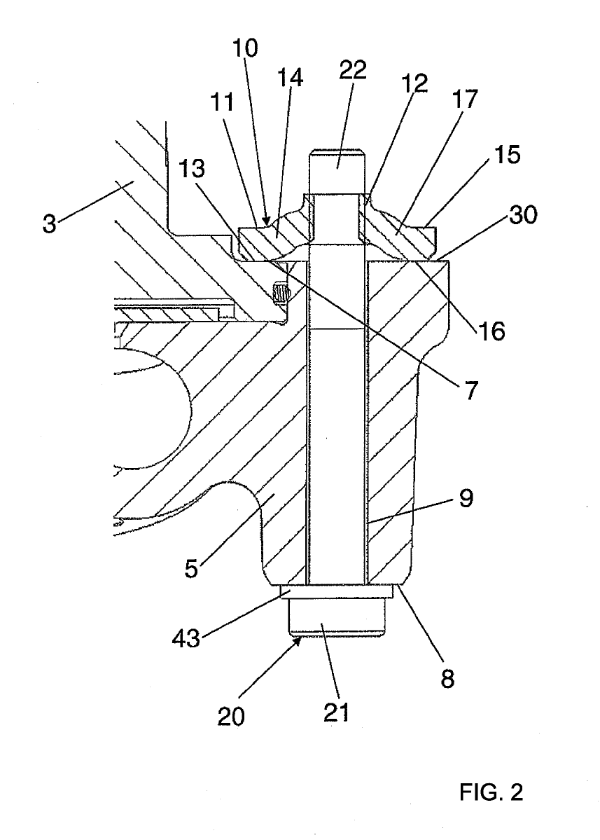

FIG. 2 shows a partial view of a cross section through another preferred embodiment of an exhaust gas turbocharger according to the invention;

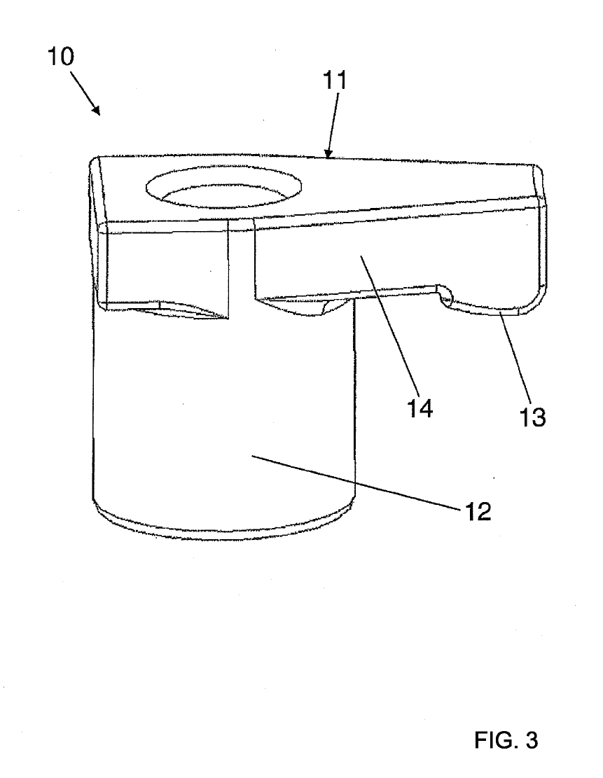

FIG. 3 shows a perspective view of a preferred embodiment of a clamping device for the exhaust gas turbocharger according to the invention shown in FIG. 1;

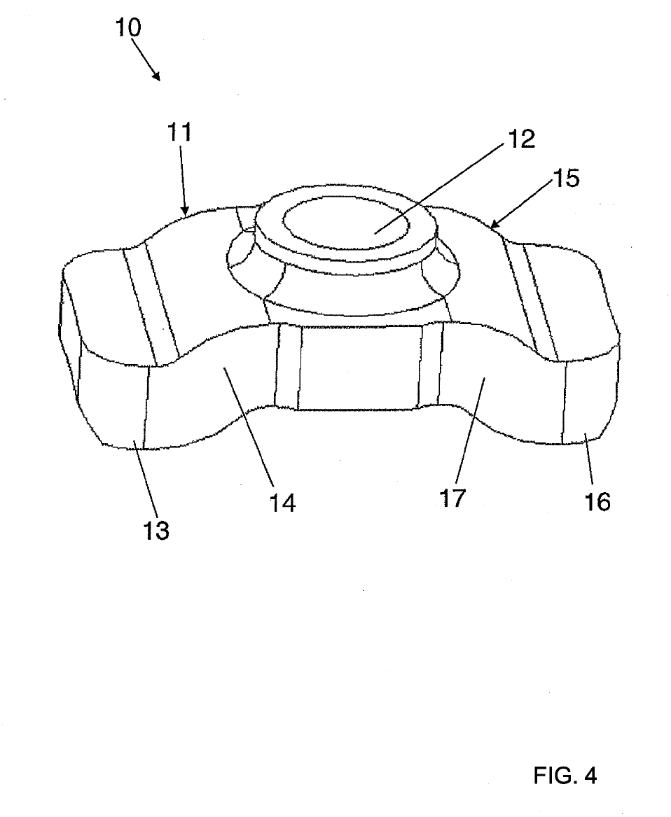

FIG. 4 shows a perspective view of another preferred embodiment of a clamping device for the exhaust gas turbocharger according to the invention shown in FIG. 2; and

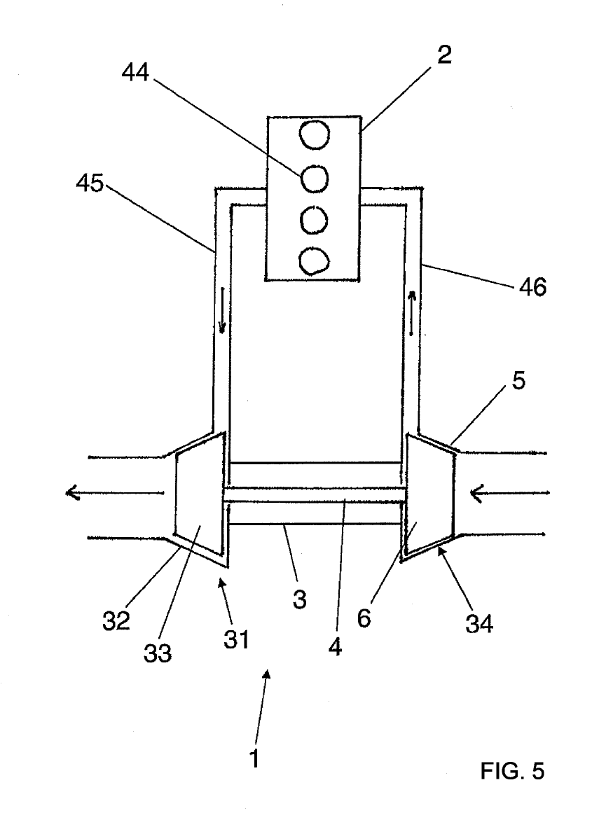

FIG. 5 shows a plan view of a preferred embodiment of an internal combustion engine having an exhaust gas turbocharger according to the invention as shown in FIG. 1 or FIG. 2.

In the figures of the drawing, identical components, elements and features are provided with identical reference signs, unless otherwise stated.

FIG. 1 illustrates a partial view of a cross section through a preferred embodiment of an exhaust gas turbocharger according to the invention.

FIG. 1 first of all shows two housing components 3, 5, which are designed as the bearing housing 3 and the compressor housing 5 of an exhaust gas turbocharger. The bearing housing 3 has a bearing housing flange 35, which is preferably circular and has an outer surface 36 which is preferably of cylindrical design. As an alternative, the bearing housing flange 35 can also have a rectangular or any other geometrical shape. The preferably cylindrical outer surface 36 is guided on an inner surface 37, of correspondingly cylindrical design, of a compressor housing flange 38. In an alternative embodiment of the exhaust gas turbocharger according to the invention, the bearing housing is embodied with a cylindrical inner surface, and the compressor housing 5 is embodied in corresponding fashion with a cylindrical outer surface. The bearing housing flange 35 has a sealing ring groove 39, which is arranged on the cylindrical outer surface 36 and preferably runs around the entire bearing housing flange 35. Arranged in the sealing ring groove 39 is a sealing ring 40. The sealing ring 40 is preferably embodied as an O-ring. The bearing housing flange furthermore has an axial contact surface 41, which is aligned approximately perpendicularly to the cylindrical outer surface 36. A surface 7 of the bearing housing 3 is arranged approximately parallel to and at a distance from the axial contact surface 41 of the bearing housing 3. The compressor housing flange 38 has an axial contact surface 42, which is approximately perpendicular to the cylindrical inner surface 37 of the compressor housing flange 38. The axial contact surface 42 of the compressor housing flange 38 touches the axial contact surface 41 of the bearing housing flange 35. The compressor housing 5 furthermore has a first surface 8 and a second surface 30. The second surface 30 forms an outer boundary of the compressor housing flange 38. The first surface 8 and the second surface 30 are approximately perpendicular to the cylindrical inner surface 37 of the compressor housing flange 38. The first surface 8 and the second surface 30 are arranged at a distance from one another, wherein the axial contact surface 42 of the compressor housing flange 38 is arranged between the first surface 8 and the second surface 30. The compressor housing 5 has apertures 9, which are preferably arranged in a manner uniformly distributed around a flange circumference of the compressor housing flange 38. The aperture 9 is preferably aligned parallel to the cylindrical inner surface 37 of the compressor housing flange 38. The housings 3, 5 are preferably embodied as cast metal components, wherein the surfaces 7, 8, 30, 36, 37, 41, 42 are preferably machined to produce an appropriate surface finish.

FIG. 1 furthermore shows a counter-clamping device 20, which is passed through the aperture 9. The counter-clamping device 20 has a head section 21 and a counter-engagement section 22. The counter-clamping device 20 is designed as a fillister-head screw, for example. The head section 21 of the counter-clamping device 20 is arranged on the first surface 8 of the compressor housing 5. A washer 43 is preferably provided between the head section 21 and the first surface 8. An engagement section 12 of a clamping device 10 is in positive contact with the counter-engagement section 22 of the counter-clamping device 20. The engagement section 12 is preferably provided with an internal thread, which interacts with a corresponding external thread on the counter-engagement section 22 of the counter-clamping device 20. The clamping device 10 furthermore has a first arm section 11. The arm section 11 of the clamping device 10 has a first bearing section 13 and a first intermediate section 14. The first bearing section 13 arches beyond the first intermediate section 14 in the axial direction of the clamping device 10.

The bearing housing 3 is preferably embodied as a cast-iron component. The clamping device 10 and the counter-clamping device 20 are preferably constructed from steel materials, and the compressor housing 5 is preferably formed from a cast aluminum alloy. As an alternative, it is also possible for various other metallic materials, ceramic materials and/or composite materials to be used for the abovementioned components.

A multiplicity of clamping devices 10 and counter-clamping devices 20 is preferably arranged in a manner uniformly distributed around the circumference of the compressor housing flange 38. The operation of the clamping device 10 and of the counter-clamping device 20 is described below by way of example for an arrangement having a clamping device 10 and a counter-clamping device 20. The first bearing section 13 of the clamping device 10 is preferably in linear contact with the surface 7 of the bearing housing 3. When the counter-clamping device 20 is actuated, e.g. by screwing the counter-clamping section 22 of the counter-clamping device 20 into the engagement section 12 of the clamping device 10, the counter-clamping device 20 transmits a contact force to the surface 7 of the bearing housing 3 from the first surface 8 of the compressor housing 5, via the washer 43, the head section 21, the positive contact between the engagement section 12 and the counter-engagement section 22, the first intermediate section 14 and the first bearing section 13. As a result, the axial contact surface 41 of the bearing housing flange 35 is pressed against the axial contact surface 42 of the compressor housing flange 38. The bearing housing 3 is thus fixed nonpositively on the compressor housing 5. The fact that the head section 21 and the washer 43 have a sufficiently large contact surface with the first surface 8 of the compressor housing 5 results in a very small surface pressure between the head section 21 and washer 43 and the first surface 8 of the compressor housing 5. By virtue of the fact that the clamping device 10 and, in particular, the first arm section 11 are preferably made of a spring-elastic material, a sufficiently large preload can be produced, reliably preventing unwanted release of the positive connection between the counter-engagement section 22 of the counter-clamping device 20 and the engagement section 12 of the clamping device 10. The surface 7 of the bearing housing 3 is set back somewhat in the axial direction relative to the second surface 30 of the compressor housing 5. By virtue of the fact that the first bearing section 13 of the clamping device 10 arches beyond the first intermediate section 14 of the clamping device, the first arm section 11 bridges said axial offset between the bearing housing 3 and the compressor housing 5.

During the assembly of an exhaust gas turbocharger according to the invention, a turbine housing is first of all clamped on a corresponding assembly fixture. The bearing 3 is then screwed to the turbine housing by means of tie bolts. In this process, the tie bolts are preferably passed through corresponding apertures in the bearing housing 3 and screwed into corresponding threaded holes in the turbine housing. The tie bolts are installed from above in a plan view of the assembly fixture. The compressor housing is then placed on this preassembled unit consisting of the turbine housing and the bearing housing 3, which is clamped unchanged in the clamping fixture. The clamping devices 10 and the counter-clamping devices 20 are preferably fed in and brought into engagement with one another in an automated manner. Here, the direction of installation of the counter-clamping devices 20 corresponds to the direction of installation of the tie bolts of the turbine housing. A uniform direction of installation for the assembly of the housing components of the exhaust gas turbocharger is thus achieved. During assembly, the exhaust gas turbocharger does not have to be reclamped in the clamping fixture and can thus be assembled in a fully automated manner. This significantly reduces the outlay for the production of the exhaust gas turbocharger according to the invention in terms of time and costs. Moreover, it is possible to set a sufficiently large preload with the clamping devices 10, thereby reliably preventing unwanted release of the connection between the clamping devices 10 and the counter-clamping devices 20. In addition, the axial space requirement for the clamping devices 10 and the counter-clamping devices 20 in the region of the bearing housing flange 35 of the bearing housing 3 is extremely small. As a result, access for the required water and oil connections to the bearing housing 3 from the side is significantly improved.

FIG. 2 shows a partial view of a cross section through another preferred embodiment of an exhaust gas turbocharger according to the invention.

FIG. 2 shows the bearing housing 3 and the compressor housing 5 as well as the clamping device 10 and the counter-clamping device 20. The embodiment of the exhaust gas turbocharger according to the invention shown in FIG. 2 differs from the embodiment of the exhaust gas turbocharger according to the invention shown in FIG. 1 in that the clamping device 10 has a second arm section 15 with a second bearing section 16 and a second intermediate section 17. The second bearing section 17 preferably rests in a linear manner on the second surface 30 of the compressor housing 5. As an alternative, the second bearing section 17 can also form an areal contact with a surface. The clamping device 20 is guided in the aperture 9 in the compressor housing 5 with the counter-engagement section 22. The clamping device 10 is arranged in front of the second surface 30 of the compressor housing 5 and in front of the first surface 7 of the bearing housing 3, relative to an axial direction of the counter-clamping device 20.

When the counter-clamping device 20 is actuated, a contact force can be transmitted from the first surface 8 of the bearing housing to the surface 7 of the bearing housing 3 and to the second surface 30 of the compressor housing 5 via the washer 43, the head section 21 of the counter-clamping device 20, the positive connection between the counter-engagement section 22 of the counter-clamping device 20 and the engagement section 12 of the clamping device 10, the first intermediate section 14 and the second intermediate section 17. The contact force is thus distributed between the surface 7 of the bearing housing 3 and the second surface 30 of the compressor housing 5. As a result, the surface pressure between the first bearing section 13 and the surface 7 of the bearing housing 3 is significantly reduced. The exhaust gas turbocharger according to the invention is assembled in the same way as that already described with reference to FIG. 1.

FIG. 3 illustrates a perspective view of a preferred embodiment of a clamping device of the exhaust gas turbocharger according to the invention shown in FIG. 1.

The engagement section 12 of the clamping device 10 is preferably embodied as a cylinder with an axial threaded through hole. The first arm section 11 with the first intermediate section 14 and the first bearing section 13 is provided on an end face of said cylinder. The threaded hole also extends through the first arm section 11. In a plan view, the first arm section 11 is of approximately frustoconical design, wherein the lateral edges of the frustocone taper toward one another, starting from the circumferential surface of the cylindrical engagement section 12. The first bearing section 13 is designed as an arch projecting beyond the first intermediate section 14 of the first arm section 11.

Relative to the circumferential surface of the engagement section 12, the first arm section 11 extends approximately perpendicularly away from said surface. The upper side of the first arm section 11 and the underside of the first arm section 11 run approximately parallel in the region of the first intermediate section. The first bearing section 13 is shaped in such a way that a linear or, alternatively, areal contact is formed when there is contact between the first bearing section 13 and a flat surface.

The clamping device 10 is preferably composed of an elastic material, in particular a spring-elastic material. As an alternative, it is also possible for just the first intermediate section 14 to be composed of an elastic material, in particular a spring-elastic material.

FIG. 4 shows a perspective view of another preferred embodiment of a clamping device of the exhaust gas turbocharger according to the invention shown in FIG. 2.

FIG. 4 shows the clamping device 10 having the first arm section 11, the first intermediate section 14 and the first bearing section 13. The clamping device 10 furthermore has the engagement section 12 and the second arm section 15 with the second intermediate section 17 and the second bearing section 16. The engagement section 12 is embodied as a cylinder with a threaded through hole running in the longitudinal direction. Starting from the circumferential surface of the cylindrical engagement section 12, the first arm section 11 and the second arm section 15 extend radially outward at an offset angle of about 180 degrees. Starting from the first bearing section 13, the first arm section 11 first of all runs approximately perpendicularly to the circumferential surface of the engagement section 12 and then merges into the first intermediate section 14, which runs at an angle to the circumferential surface of the engagement section 12. The first arm section 11 then once again runs approximately perpendicularly to the circumferential surface of the engagement section 12 and merges into the circumferential surface. The second arm section 15 is arranged as a mirror image of the first arm section 11 relative to a center plane of the engagement section 12. The first bearing section 13 and the second bearing section 16 are shaped in such a way that there is linear or areal contact when the clamping device 10 is resting on a surface. When the clamping device 10 is viewed from the side, it has a curved shape, e.g. that of a diaphragm spring, owing to the above-described shape of the arm sections 11, 15.

FIG. 5 shows a plan view of a preferred embodiment of an internal combustion engine having an exhaust gas turbocharger according to the invention as shown in FIG. 1 or FIG. 2.

An internal combustion engine 2 having a plurality of cylinders 44 is coupled fluidically by an exhaust line 45 to a turbine wheel 33 of a turbine 31, said turbine wheel being arranged in a turbine housing 32. The turbine wheel 33 is connected to a compressor wheel 6 for conjoint rotation by a turbocharger shaft 4. The turbocharger shaft 4 is supported in the bearing housing 3. The compressor wheel 6 is arranged in the compressor housing 5 of a compressor 34 of an exhaust gas turbocharger 1. The compressor wheel 6 is coupled fluidically to the internal combustion engine 2 by an intake section 46.

During the operation of the internal combustion engine 2 having the exhaust gas turbocharger 1, the internal combustion engine 2 makes exhaust gas available to the turbine wheel 33 via the exhaust line 45. By means of the turbine wheel 33, the energy of the exhaust gas is lowered, and the kinetic and thermal energy of the exhaust gas are converted into rotational energy. The rotational energy is transmitted to the compressor wheel 6 via the turbocharger shaft 4. The compressor wheel 6 draws in fresh air, compresses it and feeds the compressed fresh air to the internal combustion engine 2 via the intake section 46.

By virtue of the fact that there is more oxygen in the compressed air volume per unit volume, more fuel can be burnt in the internal combustion engine 2 per unit volume of air, thereby increasing the power yield of the internal combustion engine 2. By virtue of the fact that a sufficiently large preload can be produced between the compressor housing 5 and the bearing housing 3 in the exhaust gas turbocharger 1 according to the invention, the operational safety of the exhaust gas turbocharger 1 according to the invention and of the internal combustion engine 2 operated with the exhaust gas turbocharger 1 is increased. Moreover, the exhaust gas turbocharger 1 according to the invention can be produced in an automated manner and hence in a reduced time and at reduced cost in comparison with known solutions. This reduces the costs for the exhaust gas turbocharger 1 according to the invention and for the internal combustion engine 2 coupled to the exhaust gas turbocharger 1 according to the invention.

Although the present invention has been described fully with reference to preferred embodiments, it is not restricted to these but can be modified in many different ways. In particular, features of the individual embodiments described above can be combined in any desired manner, provided this makes sense technically.

In a preferred modification of the present invention, the positive connection between the engagement section of the clamping device and the counter-engagement section of the counter-clamping device is not implemented by means of a screwed fastening but by means of a latching or snap-action joint. Particularly simple and rapid assembly of the exhaust gas turbocharger according to the invention is thereby possible.

The materials, numerical data and dimensions presented are to be taken as illustrative and serve merely to explain the embodiments and developments of the present invention.

The indicated exhaust gas turbocharger can be used to particular advantage in the motor vehicle sector and, in this sector, can preferably be used for passenger vehicles, e.g. with diesel or spark ignition engines, but can also be used in any other turbocharger applications, if required.

1-14. (canceled)

15. An exhaust gas turbocharger, comprising:
a bearing housing for supporting a rotor shaft;
a compressor housing for receiving a compressor wheel;
a clamping device formed with a first arm section and an engagement section, wherein the first arm section rests at least partially on a surface of said bearing housing; and
a counter-clamping device having a head section and a counter-engagement section, said head section resting at least partially on a first surface of said compressor housing, and wherein said counter-engagement section can be brought into positive contact with said engagement section such as to connect said bearing housing and said compressor housing to one another with a force-lock.

16. The exhaust gas turbocharger according to claim 15, wherein said counter-clamping device is passed at least partially through an aperture formed in said compressor housing.

17. The exhaust gas turbocharger according to claim 15, wherein said arm section has a first bearing section configured to rest on the surface of said bearing housing and a first intermediate section for transmitting a force from said engagement section of said clamping device to said first bearing section.

18. The exhaust gas turbocharger according to claim 17, wherein said first bearing section forms a linear contact region with the surface of said bearing housing.

19. The exhaust gas turbocharger according to claim 15, wherein said clamping device includes elastic material, thereby making it possible to produce a preload between said bearing housing and said compressor housing.

20. The exhaust gas turbocharger according to claim 19, wherein said clamping device comprises of a spring-elastic element.

21. The exhaust gas turbocharger according to claim 15, wherein said engagement section and said counter-engagement section are formed with thread turns forming the positive, form-locking contact.

22. The exhaust gas turbocharger according to claim 15, wherein said engagement section is arranged at least partially between said first surface of said compressor housing and the surface of said bearing housing in a connected state of said bearing housing and of said compressor housing.

23. The exhaust gas turbocharger according to claim 15, wherein said clamping device has a second arm section that rests at least partially on a second surface of said compressor housing, and wherein the second surface is arranged substantially in an opposite direction to and at a distance from said first surface of said compressor housing.

24. The exhaust gas turbocharger according to claim 23, wherein said second arm section of said clamping device has a second bearing section configured to rest on said second surface of said compressor housing and a second intermediate section for transmitting a force from said engagement section of said clamping device to said second bearing section.

25. The exhaust gas turbocharger according to claim 24, wherein said second bearing section forms a linear contact region with said second surface of said compressor housing.

26. The exhaust gas turbocharger according to claim 23, wherein said engagement section of said clamping device is arranged in front of the first and second surfaces of said compressor housing and in front of the surface of said bearing housing.

27. The exhaust gas turbocharger according to claim 15, which further comprises:
a turbine having a turbine housing and a turbine wheel disposed in said turbine housing;
a compressor having said compressor housing and a compressor wheel disposed in said compressor housing;
tie bolts connecting said turbine housing to said bearing housing; and
wherein said rotor shaft connects said turbine wheel and said compressor wheel for conjoint rotation.

28. The exhaust gas turbocharger according to claim 15, configured for an internal combustion engine of a motor vehicle.

29. A motor vehicle, comprising an exhaust gas turbocharger according to claim 15.

30. A method of assembling an exhaust gas turbocharger having a turbine with a turbine housing and a turbine wheel, a compressor with a compressor housing and a compressor wheel, and a rotor shaft connecting the turbine wheel and the compressor wheel for conjoint rotation, and wherein the bearing housing and the compressor housing are connected to one another with a force-lock by a clamping device and a counter-clamping device, the method comprising the following assembly steps, to be carried out in succession:
(a) clamping the turbine housing on an assembly fixture;
(b) connecting the bearing housing to the turbine housing tie bolts, thereby passing the tie bolts through the bearing housing from a side of the bearing housing facing away from the turbine housing;
(c) connecting the compressor housing to the bearing housing the clamping device and the counter-clamping device, thereby passing the counter-clamping device through the compressor housing from a side of the compressor housing facing away from the bearing housing; and
(d) unclamping the turbine housing from the assembly fixture.
